(19) United States
(12) Patent Application Publication
(10) Pub. No.: US 2011/0113316 A1
(43) Pub. Date: May 12, 2011

(54) AUTHORING TOOLS FOR RICH INTERACTIVE NARRATIVES

(75) Inventors: Narendranath Datha, Bangalore (IN); Joseph M. Joy, Redmond, WA (US); Saurabh Subhash Kothari, Bangalore (IN); Ajay Manchepalli, Bangalore (IN); Sujith R. Warrier, Bangalore (IN)

(73) Assignee: Microsoft Corporation, Redmond, WA (US)

(21) Appl. No.: 13/008,732

(22) Filed: Jan. 18, 2011

Related U.S. Application Data
(63) Continuation-in-part of application No. 12/347,868, filed on Dec. 31, 2008.

(51) Int. Cl. G06F 17/00

(52) U.S. Cl. 715/202

(57) ABSTRACT

A rich interactive narrative (RIN) authoring system and method for creating and generating RIN documents in a graphical and visual manner. RIN documents are documents that contain multimedia content and combine narrative with interactive exploration. Embodiments of the RIN authoring system and method facilitate the creation of RIN documents without the need for the author to program or write code. Embodiments of the system and method provide a user interface for an author to select an experience stream, and place the experience stream on a timeline to indicate a desired location in time when the experience stream should appear in the RIN document. The author can define keyframes in the experience stream and edit those keyframes to define a trajectory between multiple keyframes in the RIN document. Embodiments of the system and method also allow the preview the RIN document in a preview window.

### CROSS-REFERENCE TO RELATED APPLICATIONS

This application is a continuation-in-part of a prior application entitled “Generalized Interactive Narratives” which was assigned Ser. No. 12/347,868 and filed Dec. 31, 2008.

### BACKGROUND

Creating compelling, interactive, and engaging media content (or content) using computing device can be a daunting task. This is especially true if the author of the content is not a developer or programmer. While there are many tools currently available that do a good job of allowing a user to create a constrained or restricted definition of content, there is a dearth of tools available for creating rich content.

Generally, constrained content includes traditional media such as images, video, and presentations. For example, there are many tools that allow a user to create and edit videos and images and to create presentations. Each of these tools is powerful, but they are constrained to the creation of a particular type of constrained content.

Rich content includes complex forms of media as well as interactive multimedia. In addition, rich content includes media obtained from all over the Web. For example, media on the Web includes interactive maps and visualization tools, such as Pivot (a software application from Microsoft that allows users to interact with and search large amounts of data), and PhotoSynth (a software application from Microsoft that generates a three-dimensional model of a group of digital photographs).

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of the rich interactive narrative (RIN) authoring system and method facilitate the creation of RIN documents in a visual and graphical manner. Embodiments of the system and method provide a framework that allows someone having no programming or coding background to easily create RIN documents. In addition, embodiments of the system and method are pluggable and extensible, which means that an author can create rich content by using media technology that currently exist and that may exist in the future. The content is obtained by bringing in media and multi-media from local sources and from Web sources.

A RIN document is document that combines rich multimedia content from a variety of sources in a narrative format with interactive exploration. This combination is a compelling way to present and absorb information, and is much more powerful that the narrative or interactive exploration in isolation. The RIN document is a new media type that is not tied to one particular implementation of technology. In fact, the RIN document is an extensible specification for the orchestration of multiple visualization technologies to create rich and compelling interactive narratives.

Embodiments of the RIN authoring system and method allow the author to easily and quickly generate engaging RIN documents in a simple graphical and visual manner. Using embodiments of the system and method, an author can define keyframes using one graphical user interface for multiple pluggable experience streams and orchestrate the keyframe sequences (known as trajectories or paths) through those keyframes. As explained in detail below, the phrase “experience stream” includes a scripted path through a specific environment and the associated environmental data, artifacts, and trajectory. The author may also choose to have embodiments of the system and method automatically generate portions of the RIN document while the author manually generates the remainder. The author then is free to go back and make additions to or edit the created RIN document using embodiments of the system and method.

Embodiments of the RIN authoring system include graphical user interface containing a media library, having experience streams obtained from a variety of sources and a timeline for temporally ordering selected experience streams. The timeline can have a plurality of different tracks, allowing the inclusion of various layers of audio and visual experience streams in the RIN document.

A keyframe creation and editing module allows an author to define keyframes and their associated attributes and trajectories. The author is free to add as many experience streams to the timeline as desired, and in whatever ordering. The result is a RIN document. A narrative properties module allows the author to add information to the RIN document, such as title, author, description, and so forth. A RIN document preview module facilitates the preview of the created RIN document in a preview window so that the author can review his creation. In some embodiments this preview window uses Silverlight® by Microsoft® Corporation of Redmond, Wash., in a RIN player. This gives the “What you see is what you get” (WYSIWYG) experience to the author. A RIN document publishing module provides a way for the author to publish the RIN document so that others may view.

Embodiments of the RIN authoring method include having the author select experience streams from the media library. The author then drags and drops the selected experience stream from the media library to timeline. The author places the experience stream at a location on the timeline when the experience stream should appear in the RIN document. Moreover, the author selects an experience stream from the timeline and is able to edit this selected experience stream to define keyframes that indicate a state of a viewer's experience at viewing the RIN document at any point in time that the author wants to capture.

The selection of the experience stream from the timeline launches the discovery of the type of experience stream selected and its corresponding experience-specific user interface. This experience-specific user interface enables the author to define and edit keyframes for the particular type of experience stream. For example, an interactive map visualization experience stream will have one type of experience-specific user interface, while a PhotoSynth experience stream will have a different type of experience-specific user interface.

The experience-specific user interface allows the author to define keyframes from the experience stream. These keyframes indicate what the author wants a viewer to see at any point in time in the RIN document. Using the experience-specific user interface, the author can define for each keyframe a zoom level a duration of time to stay at each keyframe, and the speed to go from one keyframe to another. Moreover, using the experience-specific user interface the author can define a trajectory for the keyframes, which is a sequence of how the keyframes are shown in the RIN document.

The author can add as many experience streams as desired. Further, the author can define and edit keyframes for these experience streams as desired. Once the author is finished adding experience streams, then the author has the option to add narrative properties to the RIN document. In addition, the author can optionally have embodiments of the RIN authoring system and method generate a visual table of contents. In some embodiments this visual table of contents is animated using the experience streams and keyframes. The visual table of contents is automatically created using metadata, experience streams, keyframes, and other data associated with the RIN document.

Once the author has created the RIN document, embodiments of the method allows the author to preview the RIN document in the preview window. If the author desires additional changes, these changes can be made using the above-described method. If the author is satisfied with the RIN document that has been created, then the author may publish it for others to view and enjoy.

It should be noted that alternative embodiments are possible, and steps and elements discussed herein may be changed, added, or eliminated, depending on the particular embodiment. These alternative embodiments include alternative steps and alternative elements that may be used, and structural changes that may be made, without departing from the scope of the invention.

### DRAWINGS DESCRIPTION

Referring now to the drawings in which like reference numbers represent corresponding parts throughout:

FIG. 1 is a simplified diagram of a rich interactive narrative (RIN), including a narrative, scenes and segments.

FIG. 2 is a simplified diagram of a RIN segment including one or more experience streams, at least one screenplay, and a resource table.

FIG. 3 illustrates a relative position and size of an exemplary group of four experience stream viewports.

FIG. 4 is a simplified diagram of an experience stream made up of data bindings and a trajectory. The data bindings include environment data, as well as artifacts and highlighted regions. The trajectory includes keyframes and transitions, and markers.

FIG. 5 is a simplified diagram of an experience stream trajectory along with markers, artifacts and highlighted regions.

FIG. 6 is a block diagram of an embodiment of a system for processing RIN data to provide a narrated traversal of arbitrary media types and user-explorable content of the media.

FIG. 7 is a block diagram of a generalized and exemplary environment representing one way of implementing the creation, deposit, retention, accessing and playing of RIN.

FIG. 8 is a block diagram illustrating a general overview of embodiments of the RIN authoring system and method implemented in the RIN implementation environment.

FIG. 9 is a flow diagram illustrating the general operation of embodiments of the RIN authoring system and method shown in FIG. 8.

FIG. 10 is a flow diagram illustrating the operational details of embodiments of the keyframe creation and editing module shown in FIG. 8.

FIG. 11 illustrates a simplified example of a general-purpose computer system on which various embodiments and elements of the RIN authoring system and method, as described herein, may be implemented.

### DETAILED DESCRIPTION

In the following description of embodiments of a rich interactive narrative (RIN) authoring system and method reference is made to the accompanying drawings, which form a part thereof, and in which is shown by way of illustration a specific example whereby embodiments of the RIN authoring system and method may be practiced. It is to be understood that other embodiments may be utilized and structural changes may be made without departing from the scope of the claimed subject matter.

### I. Rich Interactive Narrative Data Model

In general, embodiments of the rich interactive narrative (RIN) data model described herein are made up of abstract objects that can include, but are not limited to, narratives, segments, screenplays, resource tables, experience streams, sequence markers, highlighted regions, artifacts, keyframe sequences and keyframes. The sections to follow will described these objects and the interplay between them in more detail. It should be noted that this RIN data model also is described in a co-pending application entitled “Data Model and Player Platform for Rich Interactive Narratives,” which was assigned Ser. No. 13/008,324 and was filed on Jan. 18, 2011.

### I.A. Narrative and Scenes

The RIN data model provides seamless transitions between narrated guided walkthroughs of arbitrary media types and user-explorable content of the media, all in a way that is completely extensible. In the abstract, the RIN data model can be envisioned as a narrative that runs like a movie with a sequence of scenes that follow one after another (although like a DVD movie, a RIN could be envisioned as also having isolated scenes that are accessed through a main menu). A user can stop the narrative, explore the environment associated with the current scene (or other scenes if desired), and then resume the narrative where it left off.

A scene is a sequentially-running chunk of the RIN. As a RIN plays end-to-end, the boundaries between scenes may disappear, but in general navigation among scenes can be non-linear. In one implementation, there is also a menu-like start scene that serves as a launching point for a RIN, analogous to the menu of a DVD movie.

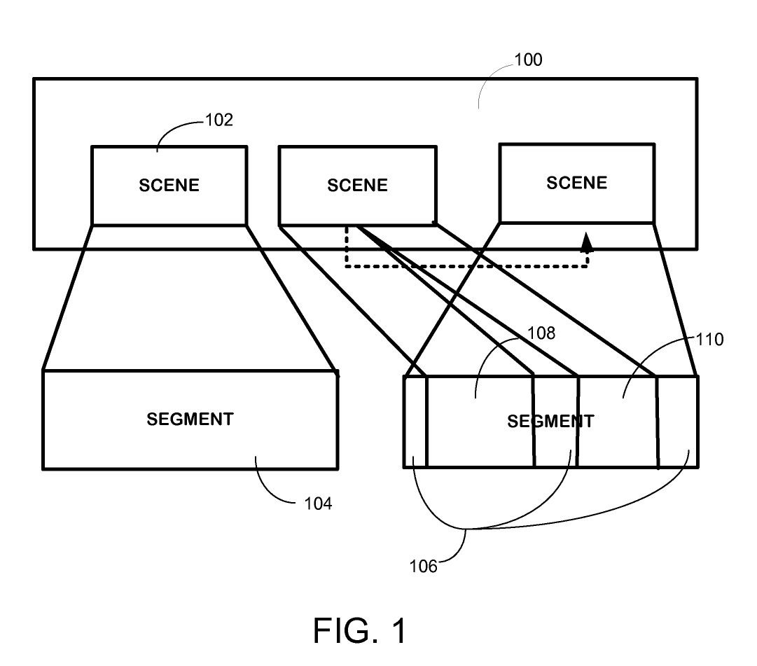

However, a scene is really just a logical construct. The actual content or data that constitutes a linear segment of a narrative is contained in objects called RIN segments. FIG. 1 is a simplified diagram of a rich interactive narrative (RIN), including a narrative, scenes and segments. As shown in FIG. 1, a scene 102 of a RIN 100 can be composed of a single RIN segment 104, or it can be put together using all or portions of multiple segments 106, 108, 110 (some of which can also be part of a different scene). Thus, a scene can be thought of as references into content that is actually contained in RIN segments. Further, it is possible for a scene from one RIN to reference RIN segments from other RINs. This feature can be used to, for example, create a lightweight summary RIN that references portions of other RINs. Still further, one RIN segment may play a first portion of an experience stream and the next RIN segment plays a remaining portion of the segment. This can be used to enable seamless transitions between scenes, as happens in the scenes of a movie.

In one embodiment of the RIN data model, a provision is also made for including auxiliary data. All entities in the model allow arbitrary auxiliary data to be added to that entity. This data can include, for example (but without limitation), the following. It can include metadata used to describe the other data. It can also include data that fleshes out the entity, which can include experience-stream specific content. For example, a keyframe entity (i.e., a sub-component of an experience stream, both of which will be described later) can contain an experience-stream-specific snapshot of the experience-stream-specific state.

The auxiliary data can also be data that is simply tacked on to a particular entity, for purposes outside the scope of the RIN data model. This data may be used by various tools that process and transform RINs, in some cases for purposes quite unrelated to playing of a RIN. For example, the RIN data model can be used to represent annotated regions in video, and there could be auxiliary data that assigns certain semantics to these annotations (say, identifies a “high risk” situation in a security video), that are intended to be consumed by some service that uses this semantic information to make some business workflow decision (say precipitate a security escalation). The RIN data model can use a dictionary entity called Auxiliary Data to store all the above types of data. In the context of the narrative, metadata that is common across the RIN segments, such as, for example, descriptions, authors, and version identifiers, are stored in the narrative's Auxiliary Data entity.

### I.B. RIN Segment

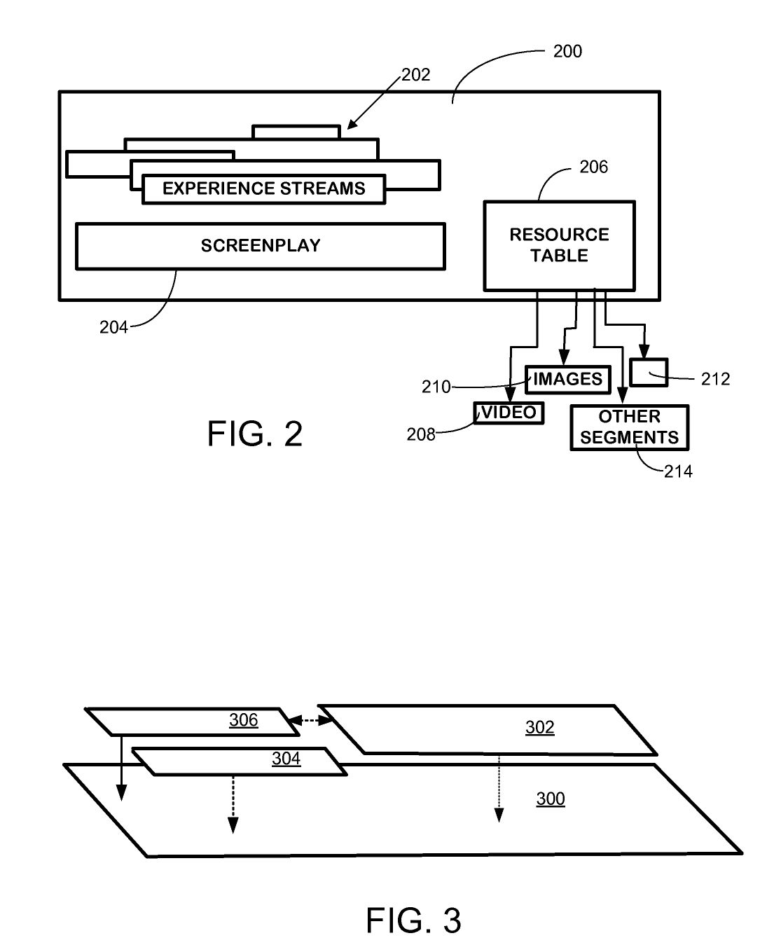

A RIN segment contains references to all the data necessary to orchestrate the appearance and positioning of individual experience streams for a linear portion of a RIN. FIG. 2 is a simplified diagram of a RIN segment including one or more experience streams, at least one screenplay, and a resource table. Referring to FIG. 2, the highest level components of the RIN segment 200 include one or more experience streams 202 (in the form of the streams themselves or references to where the streams can be obtained), at least one screenplay 204 and a resource table 206. The RIN segment can also include arbitrary auxiliary data as describe previously. In one implementation, a RIN segment takes the form of a 4-tuple (S, C, O, A). S is a list of references to experience streams; C (which is associated with the screenplay) is a list layout constraints that specify how the experience streams share display screen and audio real estate; O (which is also associated with the screenplay) is a set of orchestration directives (e.g., time coded events); and A (which is associated with the resource table) is a list of named, time coded anchors, used to enable external references.

In general, the experience streams compose to play a linear segment of the narrative. Each experience stream includes data that enables a scripted traversal of a particular environment. Experience streams can play sequentially, or concurrently, or both, with regard to other experience streams. However, the focus at any point of time can be on a single experience stream (such as a Photosynth Synth), with other concurrently playing streams having secondary roles (such as adding overlay video or a narrative track). Experience streams are described in more detail below.

In general, a screenplay is used to orchestrate the experience streams, dictating their lifetime, how they share screen and audio real estate, and how they transfer events among one another. Only one screenplay can be active at a time. However, in one implementation, multiple screenplays can be included to represent variations of content. For example, a particular screenplay could provide a different language-specific or culture-specific interpretation of the RIN segment from the other included screenplays.

More particularly, a screenplay includes orchestration information that weaves multiple experience streams together into a coherent narrative. The screenplay data is used to control the overall sequence of events and coordinate progress across the experience streams. Thus, it is somewhat analogous to a movie script or an orchestrator conductor's score. The screenplay also includes layout constraints that dictate how the visual and audio elements from the experience streams share display screen space and audio real estate as a function of time. In one implementation, the screenplay also includes embedded text that matches a voiceover narrative, or otherwise textually describes the sequence of events that make up the segment. It is also noted that a screenplay from one RIN segment can reference an experience stream from another RIN segment.

However, the orchestration information associated with the screenplay can go beyond simple timing instructions such as specifying when a particular experience stream starts and ends. For example, this information can include instructions whereby only a portion of an experience stream is played rather than the whole stream, or that interactivity capabilities of the experience stream be disabled. Further, the screenplay orchestration information can include data that enables simple interactivity by binding user actions to an experience stream. For example, if a user “clicks” on prescribed portion of a display screen, the screenplay may include an instruction which would cause a jump to another RIN segment in another scene, or to shut down a currently running experience stream. Thus, the screenplay enables a variety of features, including non-linear jumps and user interactivity.

An experience stream generally presents a scene from a virtual “viewport” that the user sees or hears (or both) as he or she traverses the environment. For example, in one implementation a two-dimensional (2D) viewport is employed with a pre-defined aspect ratio, through which the stream is experienced, as well as, optionally, audio specific to that stream is heard. The term viewport is used loosely, as there may not be any viewing involved. For example, the environment may involve only audio, such as a voiced-over narrative, or a background score.

With regard to the layout constraints, the screenplay includes a list of these constraints which are applicable to the aforementioned viewports created by the experience streams involved in the narrative. In general, these layout constraints indicate the z-order and 2D layout preferences for the viewports, well as their relative sizes.

For example, suppose four different experience streams are running concurrently at a point in time in a narrative. Layout constraints for each experience stream dictate the size and positioning of each streams viewport. FIG. 3 illustrates a relative position and size of an exemplary group of four experience stream viewports. Referring to FIG. 3, an exemplary configuration of the viewports 300, 302, 304, 306 for each of the four experience streams is shown relative to each other. In addition, in implementations where audio is involved, the layout constraints specify the relative audio mix levels of the experience streams involving audio. These constraints enable the proper use of both screen real estate and audio real estate when the RIN is playing. Further, in one implementation, the relative size and position of an experience stream viewport can change as a function of time. In other words, the layout can be animated.

Thus, each experience stream is a portal into a particular environment. The experience stream projects a view onto the presentation platform's screen and sound system. A narrative is crafted by orchestrating multiple experience streams into a storyline. The RIN segment screenplay includes layout constraints that specify how multiple experience stream viewports share screen and audio real estate as a function of time.

In some embodiments, the layout constraints also specify the relative opacity of each experience stream's viewport. Enabling experience streams to present a viewport with transparent backgrounds give great artistic license to authors of RINs. In one implementation, the opacity of a viewport is achieved using a static transparency mask, designated transparent background colors, and relative opacity levels. It is noted that this opacity constrain feature can be used to support transition functions, such as fade-in/fade-out.

With regard to audio layout constraints, in one implementation, these constraints are employed to share and merge audio associated with multiple experience streams. This is conceptually analogous to how display screen real estate is to be shared, and in fact, if one considers 3D sound output, many of the same issues of layout apply to audio as well. For example, in one version of this implementation a relative energy specification is employed, analogous to the previously-described opacity specification, to merge audio from multiple experience streams. Variations in this energy specification over time are permissible, and can be used to facilitate transitions, such as audio fade-in/fade-out.

As for the aforementioned resource table, it is generally a repository for all, or at least most, of the resources referenced in the RIN segment. All external Uniform Resource Identifiers (URIs) referenced in experience streams are resource table entries. Resources that are shared across experience streams are also resource table entries. Referring again to FIG. 2, one exemplary implementation of the resource table includes reference metadata that enables references to external media (e.g., video 208, standard images 210, gigapixel images 212, and so on), or even other RIN segments 214, to be robustly resolved. In some implementations, the metadata also includes hints for intelligently scheduling content downloads; choosing among multiple options if bandwidth becomes a constraint; and pausing a narrative in a graceful manner if there are likely going to be delays due to ongoing content uploads.

### I.C. RIN Experience Streams

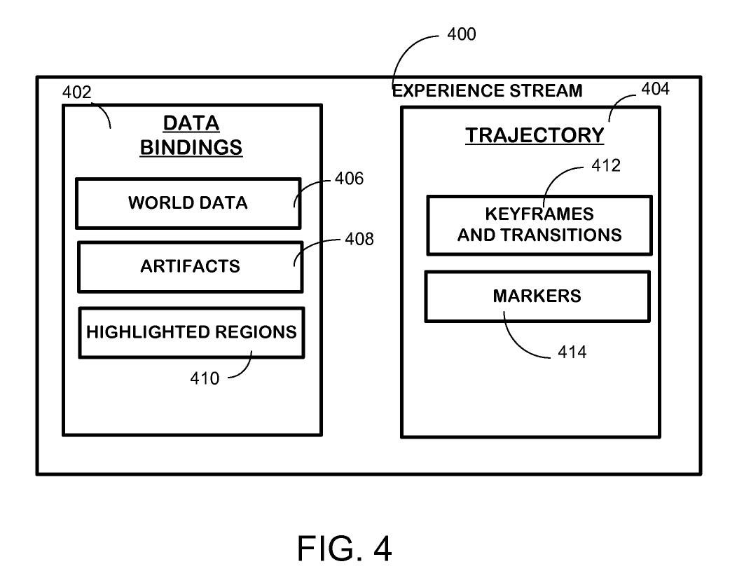

The term “experience stream” is generally used to refer to a scripted path through a specific environment. In addition, experience streams support pause-and-explore and extensibility aspects of a RIN. FIG. 4 is a simplified diagram of an experience stream made up of data bindings and a trajectory. In the embodiment illustrated in FIG. 4, an experience stream 400 is made up of data bindings 402 and a trajectory 404. The data bindings include environment data 406, as well as artifacts 408 and highlighted regions 410. The trajectory includes keyframes and transitions 412 and markers 414. An experience stream can also include auxiliary data as describe previously. For example, this auxiliary data can include provider information and world data binding information. Provider information is used in processes that render RINs, as well processes that enable authoring or processing of RINs, to bind to code that understands the specific experience stream (i.e., that understands the specific environment through which the experience is streaming). The world data binding information defines the concrete instance of the environment over which the experience streams runs.

Formally, in one implementation, an experience stream is represented by a tuple (E, T, A), where E is environmental data, T is the trajectory (which includes a timed path, any instructions to animate the underlying data, and viewport-to-world mapping parameters as will be described shortly), and A refers to any artifacts and region highlights embedded in the environment (as will also be described shortly).

Data bindings refer to static or dynamically queried data that defines and populates the environment through which the experience stream runs. Data bindings include environment data (E), as well as added artifacts and region highlights (A). Together these items provide a very general way to populate and customize arbitrary environments, such as virtual earth, photosynth, multi-resolution images, and even “traditional media” such as images, audio, and video. However, these environments also include domains not traditionally considered as worlds, but which are still nevertheless very useful in conveying different kinds of information. For example, the environment can be a web browser; the World Wide Web, or a subset, such as the Wikipedia; interactive maps; 2D animated scalable vector graphics with text; or a text document; to name a few.

Consider a particular example of data bindings for an image experience stream in which the environment is an image—potentially a very large image such as a gigapixel image. An image experience stream enables a user to traverse an image, embedded with objects that help tell a story. In this case the environmental data defines the image. For example, the environment data could be obtained by accessing a URL of the image. Artifacts are objects logically embedded in the image, perhaps with additional metadata. Finally, highlights identify regions within the image and can change as the narrative progresses. These regions may or may not contain artifacts.

Artifacts and highlights are distinguished from the environmental data as they are specifically included to tell a particular story that makes up the narrative. Both artifacts and highlights may be animated, and their visibility may be controlled as the narrative RIN segment progresses. Artifacts and highlights are embedded in the environment (such as in the underlying image in the case of the foregoing example), and therefore will be correctly positioned and rendered as the user explores the environment. It is the responsibility of an experience stream renderer to correctly render these objects. It is also noted that the environment may be a 3D environment, in which case the artifacts can be 3D objects and the highlights can be 3D regions.

It is further noted that artifacts and region highlights can serve as a way to do content annotation in a very general, extensible way. For example, evolving regions in a video or photosynth can be annotated with arbitrary metadata. Similarly, portions of images, maps, and even audio could be marked up using artifacts and highlights (which can be a sound in the case of audio).

There are several possibilities for locating the data that is needed for rendering an experience stream. This data is used to define the world being explored, including any embedded artifacts. The data could be located in several places. For example, the data can be located within the aforementioned Auxiliary Data of the experience stream itself. The data could also be one or more items in the resource table associated with the RIN segment. In this case, the experience stream would contain resource references to items in the table. The data could also exist as external files referenced by URLs, or the results of a dynamic query to an external service (which may be a front for a database). It is noted that it is not intended that the data be found in just one of these locations. Rather the data can be located in any combination of the foregoing locations, as well as other locations as desired.

The aforementioned trajectory is defined by a set of keyframes. Each keyframe captures the state of the experience at a particular point of time. These times may be in specific units (say seconds), relative units (run from 0.0 to 1.0, which represent start and finish, respectively), or can be gated by external events (say some other experience stream completing). Keyframes in RINs capture the “information state” of an experience (as opposed to keyframes in, for instance, animations, which capture a lower-level visual layout state). An example of an “information state” for a map experience stream would be the world coordinates (e.g., latitude, longitude, elevation) of a region under consideration, as well as additional style (e.g., aerial/road/streetside/etc.) and camera parameters (e.g., angles, tilt, etc). Another example of an information state, this time for a relationship graph experience stream, is the graph node under consideration, the properties used to generate the neighboring nodes, and any graph-specific style parameters.

Each keyframe also represents a particular environment-to-viewport mapping at a particular point in time. In the foregoing image example, the mappings are straightforward transformations of rectangular regions in the image to the viewport (for panoramas, the mapping may involve angular regions, depending on the projection). For other kinds of environments, keyframes can take on widely different characteristics.

The keyframes are bundled into keyframe sequences that make up the aforementioned trajectory through the environment. Trajectories are further defined by transitions, which define how inter-keyframe interpolations are done. Transitions can be broadly classified into smooth (continuous) and cut-scene (discontinuous) categories, and the interpolation/transition mechanism for each keyframe sequence can vary from one sequence to the next.

A keyframe sequence can be thought of as a timeline, which is where another aspect of a trajectory comes into play—namely markers. Markers are embedded in a trajectory and mark a particular point in the logical sequence of a narrative. They can also have arbitrary metadata associated with them. Markers are used for various purposes, such as indexing content, semantic annotation, as well as generalized synchronization and triggering. For example, context indexing is achieved by searching over embedded and indexed sequence markers. Further, semantic annotation is achieved by associating additional semantics with particular regions of content (such as a particular region of video is a ball in play; or a region of a map is the location of some facility).

A trajectory can also include markers that act as logical anchors that refer to external references. These anchors enable named external references to be brought into the narrative at pre-determined points in the trajectory. Still further a marker can be used to trigger a decision point where user input is solicited and the narrative (or even a different narrative) proceeds based on this input. For example, consider a RIN that provides a medical overview of the human body. At a point in the trajectory of an experience stream running in the narrative that is associated with a marker, the RIN is made to automatically pause and solicit whether the user would like to explore a body part (e.g., the kidneys) in more detail. The user indicates he or she would like more in-depth information about the kidneys, and a RIN concerning human kidneys is loaded and played.

A trajectory through a photosynth is easy to envision as a tour through the depicted environment. It is less intuitive to envision a trajectory through other environments such as a video or an audio only environment. As for a video, a trajectory through the world of a video may seem redundant, but consider that this can include a “Ken Burns” style pan-zoom dive into subsections of video, perhaps slowing down or even reversing time to establish some point. Similarly, one can conceive of a trajectory through an image, especially a very large image, as panning and zooming into portions of an image, possibly accompanied by audio and text sources registered to portions of the image. A trajectory through a pure audio stream may seem contrived at first glance, but it is not always so. For example, a less contrived scenario involving pure audio is an experience stream that traverses through a 3D audio field, generating multi-channel audio as output. Pragmatically, representing pure audio as an experience stream enables manipulation of things like audio narratives and background scores using the same primitive (i.e., the experience stream) as used for other media environments.

It is important to note that a trajectory can be much more than a simple traversal of an existing (pre-defined) environment. Rather, the trajectory can include information that controls the evolution of the environment itself that is specific to the purpose of the RIN. For example, the animation (and visibility) of artifacts is included in the trajectory. The most general view of a trajectory is that it represents the evolution of a user experience—both of the underlying model and of the users view into that model.

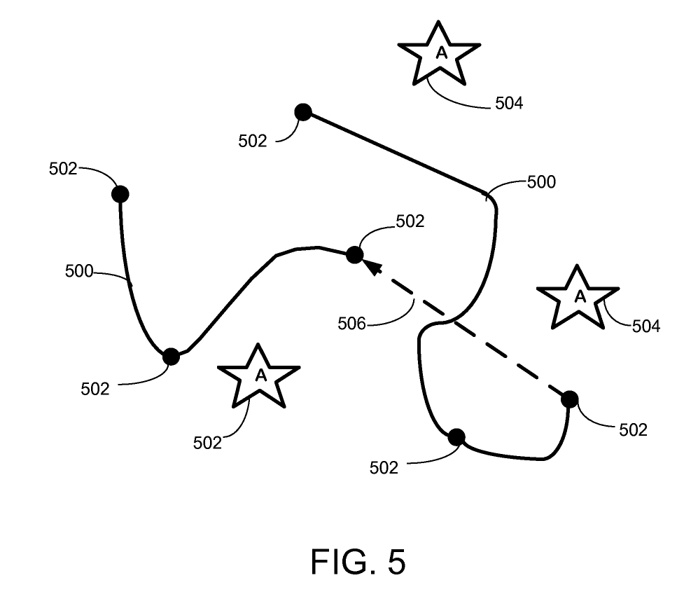

In view of the foregoing, an experience stream trajectory can be illustrated as shown in FIG. 5. FIG. 5 is a simplified diagram of an experience stream trajectory along with markers, artifacts and highlighted regions. The bolded graphics illustrate a trajectory 500 along with its markers 502 and the stars indicated artifacts or highlighted regions 504. The dashed arrow 506 represents a “hyper jump” or “cut scene”—an abrupt transition, illustrating that an experience stream is not necessarily restricted to a continuous path through an environment.

### II. Rich Interactive Narrative System Overview

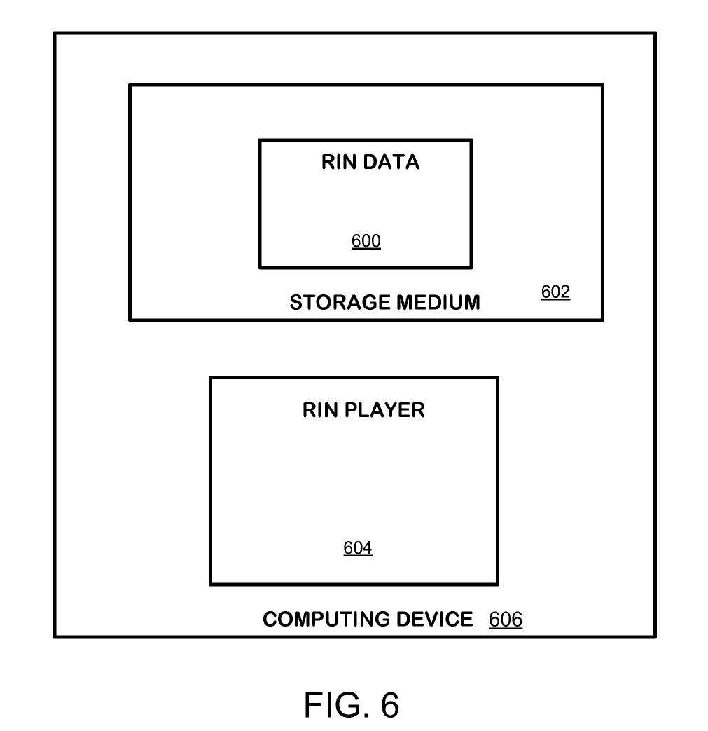

Given the foregoing RIN data model, the following exemplary system of one embodiment for processing RIN data to provide a narrated traversal of arbitrary media types and user-explorable content of the media can be realized. FIG. 6 is a block diagram of an embodiment of a system for processing RIN data to provide a narrated traversal of arbitrary media types and user-explorable content of the media. In this exemplary RIN system, the RIN data 600 is stored on a computer-readable storage medium 602 (as will be described in more detail later in the exemplary operating environments section) which is accessible during play-time by a RIN player 604 running on a user's computing device 606 (such as one of the computing devices described in the exemplary operating environments section). The RIN data 600 is input to the user's computing device 606 and stored on the computer-readable storage medium 602.

As described previously, this RIN data 600 includes a narrative having a prescribed sequence of scenes, where each scene is made up of one or more RIN segments. Each of the RIN segments includes one or more experience streams (or references thereto), and at least one screenplay. Each experience stream includes data that enables traversing a particular environment created by a one of the aforementioned arbitrary media types whenever the RIN segment is played. In addition, each screenplay includes data to orchestrate when each experience stream starts and stops during the playing of the RIN and to specify how experience streams share display screen space or audio playback configuration.

As for the RIN player 604, this player accesses and processes the RIN data 600 to play a RIN to the user via an audio playback device, or video display device, or both, associated with the user's computing device 606. The player also handles user input, to enable the user to pause and interact with the experience streams that make up the RIN.

### II.A. RIN Implementation Environment

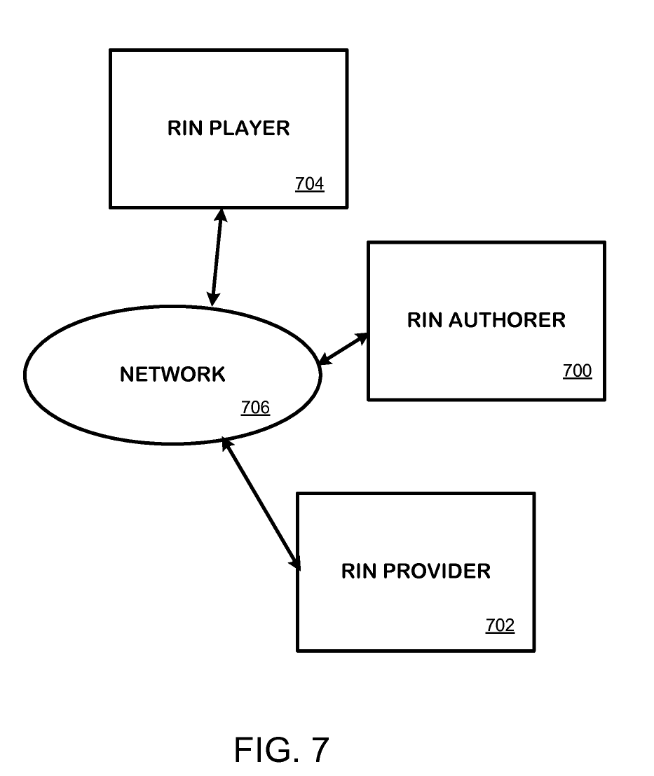

A generalized and exemplary environment representing one way of implementing the creation, deposit, retention, accessing and playing of RIN is illustrated in FIG. 7. FIG. 7 is a block diagram of a generalized and exemplary environment representing one way of implementing the creation, deposit, retention, accessing and playing of RIN. An instance of a RIN constructed in accordance with the previously-described data model is captured in a RIN document or file. This RIN document is considered logically as an integral unit, even though it can be represented in units that are downloaded piecemeal, or even assembled on the fly.

A RIN document can be generated in any number of ways. It could be created manually using an authoring tool. It could be created automatically by a program or service. Or it could be some combination of the above.

RIN documents, once authored are deposited with one or more RIN providers as collectively represented by the RIN provider block 702 in FIG. 7. The purpose of a RIN provider is to retain and provide RINs, on demand, to one or more instances of a RIN player. While the specifics on the operation of a RIN provider is beyond the scope of this application, it is noted that in one implementation, a RIN provider has a repository of multiple RINs and provides a search capability a user can employ to find a desired RIN. The RIN player or players are represented by the RIN player block 704 in FIG. 7. It should be noted that the operation and details of the RIN player 704 are beyond the scope of this application.

In the example shown in FIG. 7, the RIN authorers, RIN providers and RIN player are in communication over a computer network 706, such as the Internet or a proprietary intranet. However, this need not be the case. For example, in other implementations any one or more of the RIN authorers, RIN providers and RIN players can reside locally such that communications between them is direct, rather than through a computer network.

### III. Rich Interactive Narrative Authoring System Overview

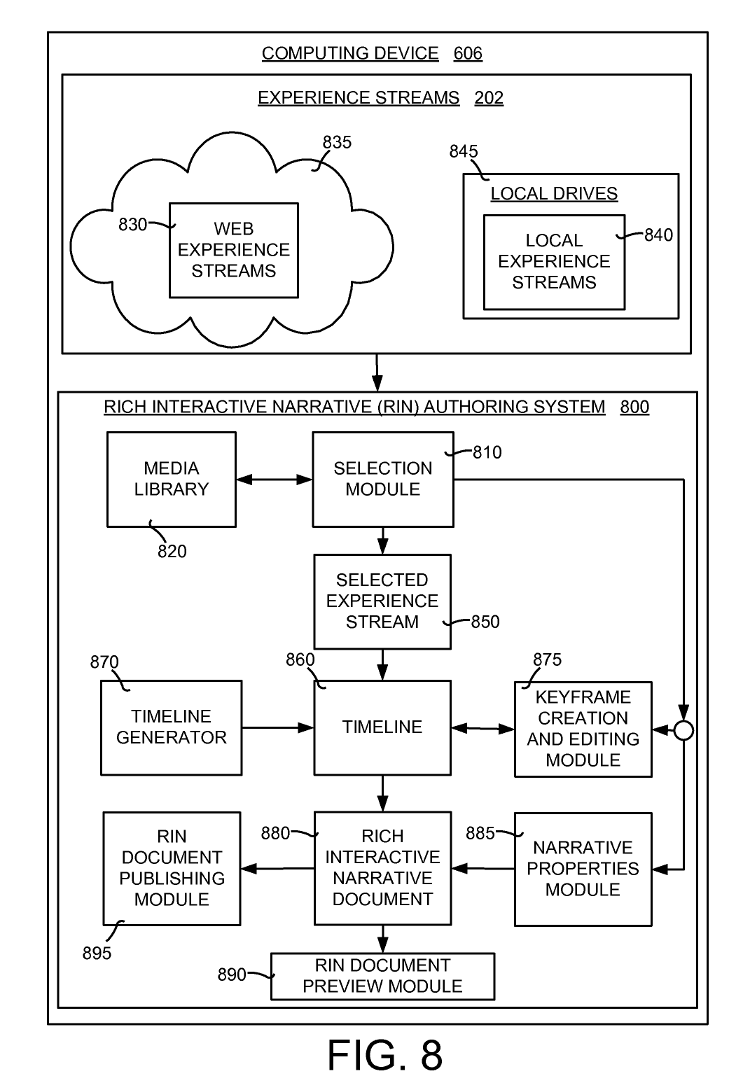

FIG. 8 is a block diagram illustrating a general overview of embodiments of the RIN authoring system 800 and method implemented in the RIN implementation environment. Note that FIG. 8 is merely one way in which embodiments of the RIN authoring system 800 and method may be implemented, and is shown merely for illustrative purposes. It should be noted that there are several other ways in which embodiments of the RIN authoring system 800 and method may be implemented, which will be apparent to those having ordinary skill in the art.

In particular, it should be noted that a RIN document does not have to be authored by using embodiments of the RIN authoring system 800 and method. In fact, the RIN document can be authored by having the author construct the implementation code (such as an XML file) for the document. In this case, the author would have no visual or graphical feedback when authoring the RIN document. Embodiments of the system 800 and method are designed to provide an author with this visual and graphical feedback and to lower the barrier to creating the RIN document such that authors having no programming or coding experience can still author the RIN document.

In general, embodiments of the RIN authoring system 800 and method allow an author to create a RIN document in a graphical manner without the need for the user to perform any programming or to write code. In addition, embodiments of the RIN authoring system 800 and method facilitate the importing of traditional media such as images, video, and text, as well as richer, more complex forms of media, such as deep zoom images, PhotoSynths, relationship graphs, and Pivot documents. This is extensible to allow importing of many more forms of media using the extensibility framework of embodiments of the authoring system 800.

Each piece of media (traditional or complex) can be placed on a timeline, in one of several layers. Furthermore a logical “path” or trajectory can be defined (by creating or defining individual “keyframes” and positioning them on the timeline) that enables a scripted walkthrough the particular piece of media. The timing of the progression through a path through each form of media can be adjusted so that when played the various pieces come together to form a compelling whole in the form of a RIN document. Creation of new keyframes, editing of existing keyframes and deletion of keyframes also is supported by embodiments of the RIN authoring system 800 and method.

Embodiments of the RIN authoring system 800 and method also support editing of an entire or a portion of existing RIN documents. In some embodiments of the system 800 and method, support for adding new experiences is facilitated without the need for recompilation. This is achieved by importing experience stream modules using dynamic loading facilities (such as Silverlight Managed Extensibility Framework). A new component can be introduced by having it expose certain standard interfaces that embodiments of the RIN authoring system 800 and method will use to create new keyframes, bind the experience to data, and so forth. Moreover, embodiments of the system 800 and method support the preview of the RIN document, the adjustment of timings on the timeline, and the adjustment of adjusting of audio levels.

As shown in FIG. 8, embodiments of the RIN authoring system 800 and method are disposed on the computing device 606 (that was originally shown in FIG. 6). Embodiments of the system 800 and method include a selection module 810, through which a user or author (not shown) can manually make selections of various entities while authoring and creating a RIN document. One selection made by the author is the selection of experience streams 202 from the media library 820. In other words, through the selection module 810 (usually in the form of a user interface), the author can select various types of experience streams 202, including video, images, interactive maps, PhotoSynths, and virtually any type of media or multimedia that now exists or will exists in the future.

The media library is populated with the experience streams 202 in a variety of different ways. In FIG. 8, at least two sources of the experience streams 202 are shown. A Web experience stream 830 is an experience stream that is obtained from the Web 835. The author can either choose to interact directly with the website containing the Web experience stream 830 or can have the media library 820 obtain it from the website. In addition, local experience streams 840 reside on local drives 845 of the computing device 606. In addition, the media library may obtain experience streams from the resource table 206 and or any other virtual or physical device in communication with the computing device 606.

In some embodiments of the RIN authoring system 800 and method, the author drags and drops a selected experience stream 850 from the media library 820 to a timeline 860. The timeline 860 is generated, either automatically by embodiments of the system 800 or manually by the author, using a timeline generator 870. The timeline generator 870 also is used to specify a number of layers (or tracks) on the timeline 860. For example, in some embodiments the timeline 860 contains multiple tracks including a media track (for dragging and dropping experience streams containing media and multimedia content), an audio overlay track (for dragging and dropping experience streams containing audio that will play over the media and multimedia experience streams at a specified time), and a background audio track (for dragging and dropping experience streams containing audio that will play in the background). These layers (or tracks) can be added by third-party developers without recompiling by extensibility mechanisms using dynamic loaded modules (such as Silverlight®'s Managed Extensiblity Framework).

Embodiments of the system 800 and method also include a keyframe creation and editing module (also known as Path Editor) 875. The keyframe creation and editing module 875 allows an author (through the selection module 810) to define a keyframe in an experience stream 202 and then define the trajectory or path of the keyframe through time. The author can select additional experience streams to add to the timeline until the author is satisfied with the creation. The result is a RIN document 880.

A narrative properties module 885 can be used by the author through the selection module 810 to attach narrative properties (such as title, description, author, and so forth) the RIN document 880. In addition, the narrative properties module 885 can automatically generate a visual table of contents, as explained in detail below. The author then can preview the RIN document 880 using a RIN document preview module 890. Based on the preview, the author may choose to further refine the RIN document 880 using embodiments of the system 800 and method described above. When the author is satisfied with the RIN document 880, it can be published using a RIN document publishing module 895.

### IV. Rich Interactive Narrative Authoring Operation

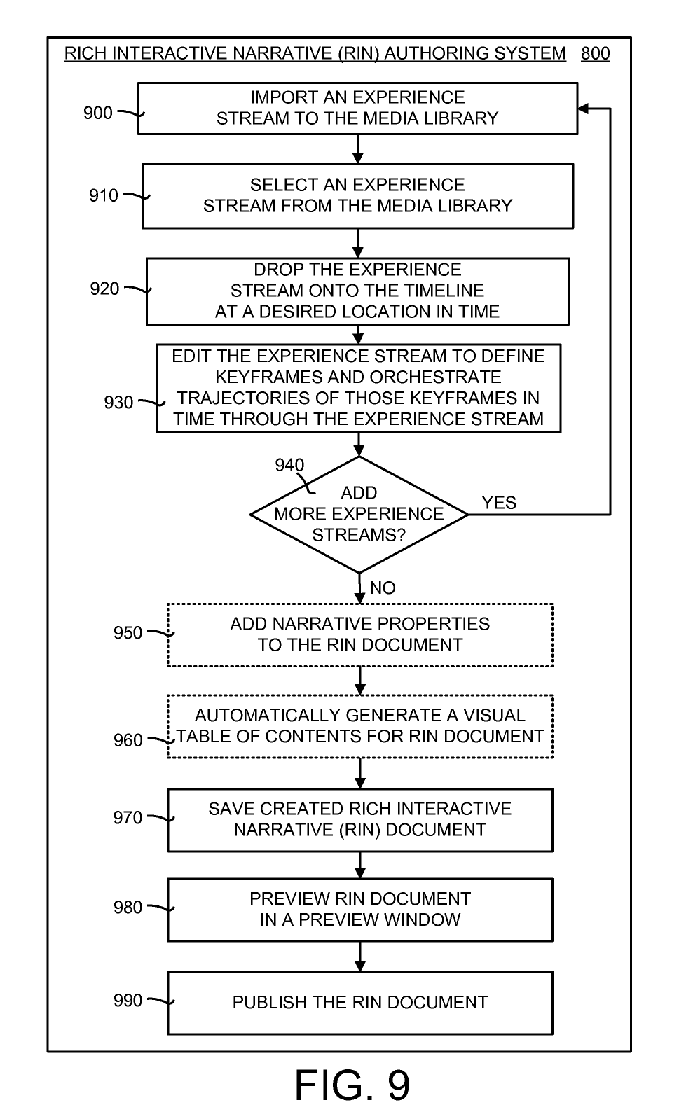

FIG. 9 is a flow diagram illustrating the general operation of embodiments of the RIN authoring system 800 and method shown in FIG. 8. In general, embodiments of the RIN authoring system 800 and method obtain facilitate the authoring of a RIN document in a graphical manner. In some embodiments, the RIN authoring system 800 and method are implemented in a graphical user interface (GUI) (not shown).

This GUI has three main parts, including a graphical representation of the media library 820, a preview window that plays and previews the RIN document for the author, and a timeline 860 where the author can place the experience streams. In addition, the GUI can include a toolbar that contains various buttons or tabs for navigating around the GUI including a “publish” button, a “new narrative” button, a “save” button, a “publish” button, and a “preview” button.

Referring to FIG. 9, the method begins by importing an experience stream to the media library 820 (box 900). In some embodiments the author clicks on the “new narrative” button to begin the process of importing experience streams to the media library. The content that can be imported includes maps, video, audio, graphs, and virtually any existing or future media or multimedia content. It should be noted that the media library 820 is quite extensible and is not hard coded. As noted above, the content or experience streams can be imported from the Web or from local drives.

The author then selects an experience stream from the media library 820 (box 910). In alternate embodiments, the author can interact directly with a website to obtain the experience stream, thereby bypassing the media library. The author then drags and drops the selected experience stream onto the timeline 860 at a desired location in time (box 920). In some embodiments, the timeline 860 contains three tracks. These tracks include an interactive media (or foreground) track for the experience streams, an audio overlay track for placing audio that will play over the foreground experience audio, and a background audio track for placing audio that will play in the background. It should be noted that the number of tracks that the timeline 860 contains can be virtually any integer number.

Embodiments of the RIN authoring method then allow the author to edit the experience stream that has been dropped onto the timeline 860 (box 920). In particular, the experience stream can be edited to define one or more keyframes in the experience stream and to orchestrate trajectories or paths in time between the keyframes through the experience stream. This editing process is described in more detail below.

A determination then is made as to whether the author would like to add more experience streams to the timeline 860 (box 940). If so, then the author can repeat the process of selecting an experience stream, dragging and dropping the selected experience stream onto the timeline 860, and editing the experience stream as desired. If not, and the user is satisfied, then the author has the option of adding narrative properties to the RIN document (box 950). These narrative properties include title, description, author, aspect ratio, and so forth. Note that the dotted line surrounding boxes 950 and 960 are used to indicate that these are optional process actions.

Next, the author can have embodiments of the system 800 automatically create a visual table of contents of the RIN document (box 960). In some embodiments, the author can press a button on the GUI and automatically have the visual table of contents created. The visual table of contents is created by embodiments of the system 800 using metadata (such as the metadata stored in the resource table 206). In addition, keyframes, timing, and other data from the RIN document are used to create the visual table of contents. The visual table of contents then is added to the RIN document.

The author then can save the created RIN document (box 970). In some embodiments, the author clicks on the “save” button in the GUI to save the created RIN document. The author then can preview the RIN document in a preview window of the GUI (box 980). In some embodiments, the author can click on the “preview” button to preview the newly-authored RIN document. If the author is satisfied, then the author can publish the RIN document at the website (box 990). In some embodiments, this is achieved by the author clicking the “publish” button in the GUI.

### IV.A. Kevframe Creation and Editing Process

As noted above, a keyframe in the context of an experience stream such as a video or an image determines to what part of the image the user wants to pan and zoom. In some embodiments, the author can click on the experience stream on the timeline and a Path Editor GUI will appear for the author to use. This allows the author to select keyframes and sections of an image as keyframes. It should be noted that often an experience stream will have multiple keyframes. The same powerful GUI is used for various experience streams that support path editing.

Keyframes represent a point in time. In other words, the keyframe is a snapshot of what needs to be presented to a viewer at a point in space of the experience. In the most general sense, the keyframe is the state of the user experience or user interface at any point in space at a given time that the author wants to capture. The keyframe represents an experience state and defines, at any point in space at a given time, what the author wants a particular experience stream to appear. Once the keyframes are captured, the author indicates where on the timeline 860 that the keyframes should appear. The author also needs to specify the sequence, and the rough timing of when they appear and disappear (in other words, a trajectory or a path).

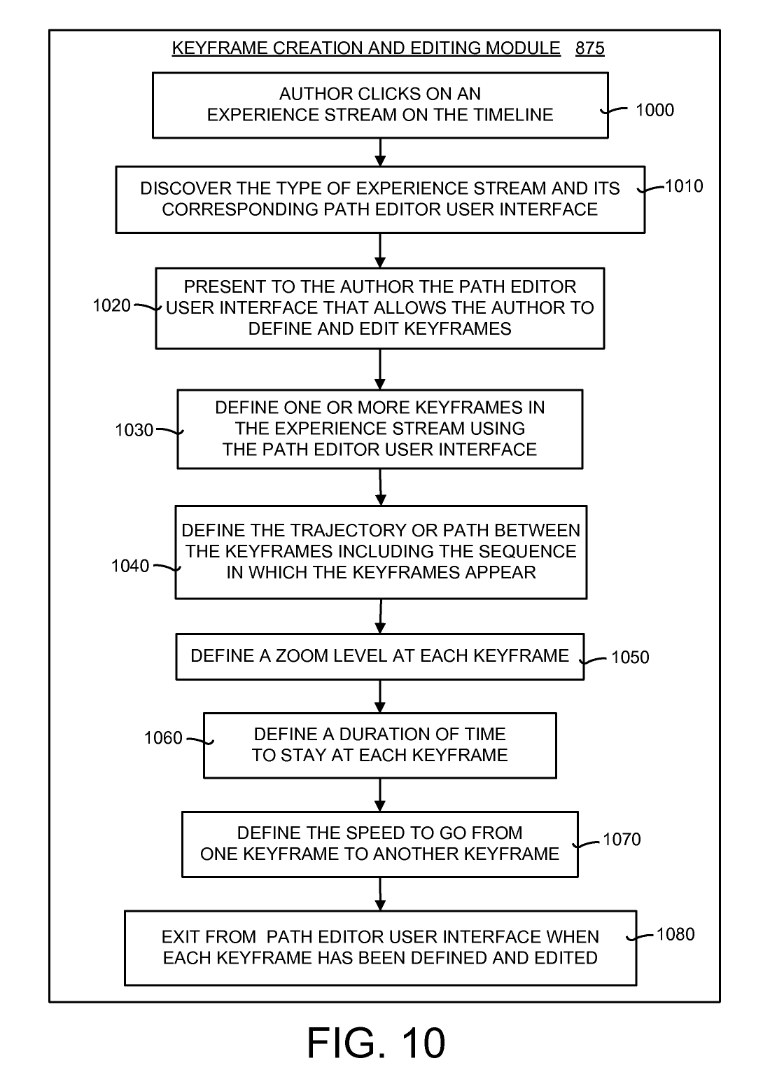

FIG. 10 is a flow diagram illustrating the operational details of embodiments of the keyframe creation and editing module 875 shown in FIG. 8. The method begins by having the author click on an experience stream that has been dropped onto the timeline 860 (box 1000). Embodiments of the module 875 then discover the type of experience stream that the author has clicked on and associate it with Path Editor user interface (box 1010).

Embodiments of the module 875 then present to the author the Path Editor user interface (box 1020). This Path Editor user interface allows the author to define and edit keyframes. As used in this context, editing keyframes also means to define various properties associated with the keyframe as well as to define the trajectory or path between a sequence of keyframes.

More specifically, the author uses the Path Editor user interface to define one or more keyframes in the experience stream (box 1030). Moreover, the author defines a trajectory or path between two or more keyframes (box 1040). This includes the sequence in which the keyframes appear. In other words, the author can place the defined keyframes on the timeline 860 in the order in which the author would like them to appear.

The author also uses the Path Editor user interface to define various features and attributes of a keyframe. In particular, the author defines a zoom level at each keyframe (box 1050). The author also defines a duration of time to stay at each keyframe during the playback of the RIN document (box 1060). In addition, the author defines a speed at which to go from one keyframe to another keyframe (box 1070). These attributes and features are part of defining and editing the keyframe. Once each of the keyframes has been defined and edited, then the author can exit from the Path Editor user interface (box 1080).

### IV.B. Overlays and Popups

In some embodiments of the RIN authoring system 800 and method, authors are able to place small overlays over background content to show related information. These overlays can contain basic media types such as image, video or text with hyperlinks. Moreover, these overlays also can contain complex interactive media, such as Photosynth or other RINs. Clicking on these will open a full screen detailed information on the clicked content.

In some embodiments of the RIN authoring system 800 and method, these popup layers are implemented as experience streams with a path and keyframes. Inclusion of these overlays and popups are easily made using embodiments of the RIN authoring system 800 and method by providing a separate overlay “track” similar to tracks provided for audio and experience stream.

### IV.C. Narratives Inside Other Narratives

In some embodiments of the RIN authoring system 800 and method, a narrative can contain other narratives. In these embodiments, users can add other narratives to an existing narrative by importing it directly into media library and adding it to experience stream layers, as with any other experience stream. This is useful to build a narrative to talk about other narratives.

The original narrative is called a “parent narrative,” while those narratives playing inside the parent narrative are called “child narratives.” It should be noted that only a section of a child narrative can be played inside a parent narrative. Thus, an author can build a narrative about highlights on other narratives. Since narrative itself is imported, the imported narrative has all the interactive capabilities as the original narrative.

### IV.D. Transitions Between Experience Streams

In some embodiments of the RIN authoring system 800 and method, various inbuilt transitions are provided between experience streams. These transitions can be of various types such as fade in, fade out, cross fade, spiral in, spiral out, and so forth. Using extensibility, developers are able to easily add new transitions by implementing an interface and dropping the implementation assembly in the authoring tool folder.

### IV.E. Use of RIN Player for Preview

Building a system to correctly preview the experience streams can be difficult. One solution is to use embodiment of the RIN player 604 as a previewer. When this is done, a number of hooks first need to be built between embodiments of the RIN authoring system 800 and the RIN player 604 for updating changes in real time and seeing changes in real time in preview area.

### IV.F. Video Projection

Video projection can be used in some embodiments of the RIN authoring system 800 and method. Video projection enables an author to create a video projection of a space-based interpolation generated using the Path Editor. This allows a faster response time for the narration where core experience streams (like Photosynth and Deep Zoom) might take an extended time to load during narration. When user gets in to the interaction mode in embodiments of the RIN player 604, the actual exploratory experience is shown to the user and during playing the video projection is shown. In some embodiments video projection can be invoked by selecting the experience on the time line and selecting a “Video Projection” option on the context menu.

### V. Exemplary Operating Environment

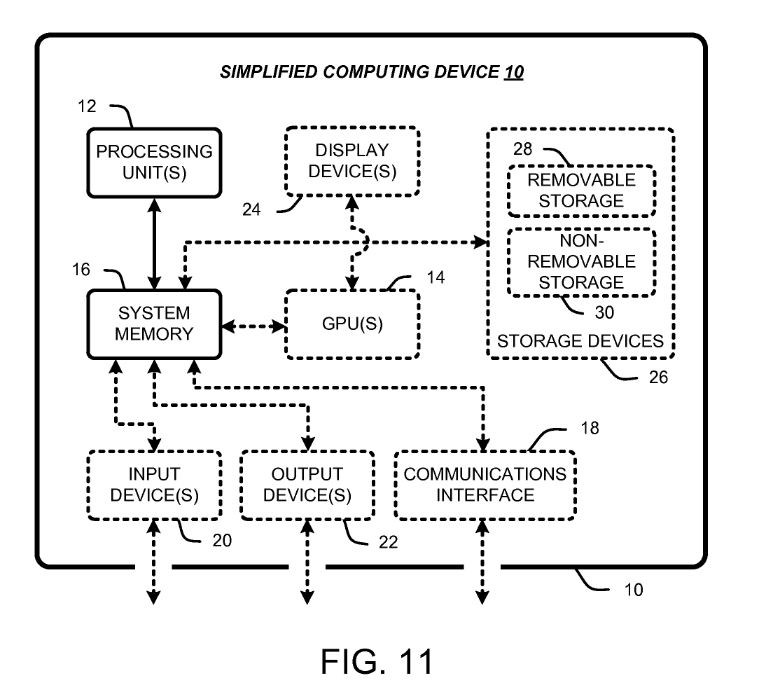

Embodiments of the RIN authoring system 800 and method described herein are operational within numerous types of general purpose or special purpose computing system environments or configurations. FIG. 11 illustrates a simplified example of a general-purpose computer system on which various embodiments and elements of the RIN authoring system 800 and method, as described herein, may be implemented. It should be noted that any boxes that are represented by broken or dashed lines in FIG. 11 represent alternate embodiments of the simplified computing device, and that any or all of these alternate embodiments, as described below, may be used in combination with other alternate embodiments that are described throughout this document.

For example, FIG. 11 shows a general system diagram showing a simplified computing device 10. Such computing devices can be typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, etc.

To allow a device to implement embodiments of the RIN authoring system 800 and method described herein, the device should have a sufficient computational capability and system memory to enable basic computational operations. In particular, as illustrated by FIG. 11, the computational capability is generally illustrated by one or more processing unit(s) 12, and may also include one or more GPUs 14, either or both in communication with system memory 16. Note that that the processing unit(s) 12 of the general computing device of may be specialized microprocessors, such as a DSP, a VLIW, or other micro-controller, or can be conventional CPUs having one or more processing cores, including specialized GPU-based cores in a multi-core CPU.

In addition, the simplified computing device of FIG. 11 may also include other components, such as, for example, a communications interface 18. The simplified computing device of FIG. 11 may also include one or more conventional computer input devices 20 (e.g., pointing devices, keyboards, audio input devices, video input devices, haptic input devices, devices for receiving wired or wireless data transmissions, etc.). The simplified computing device of FIG. 11 may also include other optional components, such as, for example, one or more conventional computer output devices 22 (e.g., display device(s) 24, audio output devices, video output devices, devices for transmitting wired or wireless data transmissions, etc.). Note that typical communications interfaces 18, input devices 20, output devices 22, and storage devices 26 for general-purpose computers are well known to those skilled in the art, and will not be described in detail herein.

The simplified computing device of FIG. 11 may also include a variety of computer readable media. Computer readable media can be any available media that can be accessed by computer 10 via storage devices 26 and includes both volatile and nonvolatile media that is either removable 28 and/or non-removable 30, for storage of information such as computer-readable or computer-executable instructions, data structures, program modules, or other data. By way of example, and not limitation, computer readable media may comprise computer storage media and communication media. Computer storage media includes, but is not limited to, computer or machine readable media or storage devices such as DVD's, CD's, floppy disks, tape drives, hard drives, optical drives, solid state memory devices, RAM, ROM, EEPROM, flash memory or other memory technology, magnetic cassettes, magnetic tapes, magnetic disk storage, or other magnetic storage devices, or any other device which can be used to store the desired information and which can be accessed by one or more computing devices.

Retention of information such as computer-readable or computer-executable instructions, data structures, program modules, etc., can also be accomplished by using any of a variety of the aforementioned communication media to encode one or more modulated data signals or carrier waves, or other transport mechanisms or communications protocols, and includes any wired or wireless information delivery mechanism. Note that the terms “modulated data signal” or “carrier wave” generally refer to a signal that has one or more of its characteristics set or changed in such a manner as to encode information in the signal. For example, communication media includes wired media such as a wired network or direct-wired connection carrying one or more modulated data signals, and wireless media such as acoustic, RF, infrared, laser, and other wireless media for transmitting and/or receiving one or more modulated data signals or carrier waves. Combinations of the any of the above should also be included within the scope of communication media.

Further, software, programs, and/or computer program products embodying the some or all of the various embodiments of the RIN authoring system 800 and method described herein, or portions thereof, may be stored, received, transmitted, or read from any desired combination of computer or machine readable media or storage devices and communication media in the form of computer executable instructions or other data structures.

Finally, embodiments of the RIN authoring system 800 and method described herein may be further described in the general context of computer-executable instructions, such as program modules, being executed by a computing device. Generally, program modules include routines, programs, objects, components, data structures, etc., that perform particular tasks or implement particular abstract data types. The embodiments described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

### VI. Additional Embodiments

It is noted that any or all of the aforementioned embodiments throughout the description may be used in any combination desired to form additional hybrid embodiments. Specifically, embodiments of the RIN authoring system 800 and method may be used to author all or just a portion of a RIN document. The author has the ability to combine automatic and manually authored portions of the RIN document.

For example, an initial version of the RIN document could be automatically generated, and this could be followed by manual addition or editing of the RIN document using embodiments of the RIN authoring system 800 and method. This in turn could be followed by additional automatically generated pieces by embodiments of the RIN authoring system 800 and method, such as the visual and animated table of contents.

Moreover, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for authoring a rich interactive narrative (RIN) document, comprising:
placing an experience stream on a timeline displayed on a computing device to indicate a desired location in time when the experience stream should appear in the RIN document;
selecting the experience stream on the timeline; and
editing the selected experience stream to define keyframes that indicate a state of a viewer's experience at viewing the RIN document at any point in time that the author wants to capture.

2. The method of claim 1, further comprising defining the experience stream as a pluggable experience stream that is extensible such that any new experience streams can easily be incorporated into the RIN document by an author of the RIN document without any need for the author to perform computer programming or to write code.

3. The method of claim 1, further comprising:
defining a plurality of keyframes in the selected experience stream; and
orchestrating trajectories of the plurality of keyframes through time in the selected experience stream to indicate a sequence of the plurality of keyframes in the RIN document.

4. The method of claim 1, further comprising:
importing the experience stream from a media library;
selecting the experience stream from the media library; and
dragging and dropping the experience stream from the media library to the timeline at the desired location in time when the experience stream should appear in the RIN document.

5. The method of claim 1, further comprising defining the timeline to have a plurality of tracks including audio tracks and visual tracks for experience streams to allow multiple layers of audio and visual experiences.

6. The method of claim 5, further comprising:
defining a foreground track for any type of experience stream that plays in the foreground of the RIN document;
defining an audio overlay track for placing audio experience streams that will play over the foreground track; and
defining a background audio track for placing audio experience streams that will play in the background of the RIN document.

7. The method of claim 1, further comprising adding narrative properties to the RIN document including a title, a description, an aspect ratio and an author.

8. The method of claim 1, further comprising automatically generating a visual table of contents for the RIN document using metadata and keyframes associated with the RIN document.

9. The method of claim 1, further comprising:
saving the RIN document;
previewing the RIN document in a preview window of a user interface presented to an author of the RIN document; and
determining whether the author is satisfied with contents of the RIN document based on the previewing.

10. The method of claim 9, further comprising:
determining that the author is satisfied with contents of the RIN document; and
publishing the RIN document for others to view.

11. The method of claim 9, further comprising:
having the author manually author a portion of the RIN document;
having the remainder of the RIN document automatically authored by the computing device; and
having the author manually add content and edit content of the RIN document.

12. A computer-implement method for defining and editing keyframes for a rich interactive narrative (RIN) document, comprising:
using the computer to perform the following process actions:
having an author of the RIN document click on an experience stream that has been place on a timeline in a user interface;
discovering a type of experience stream and its corresponding experience-specific user interface; and
presenting to the author the experience-specific user interface in which the author defines and edits keyframes for the RIN document.

13. The computer-implemented method of claim 12 further comprising defining one or more keyframes in the experience stream using the experience-specific user interface.

14. The computer-implemented method of claim 13, further comprising defining a trajectory between two or more of the keyframes to set forth a sequence in which the keyframes should appear in the RIN document.

15. The computer-implemented method of claim 14, further comprising defining a zoom level for each of the keyframes.

16. The computer-implemented method of claim 14, further comprising defining a duration of time to stay at each of the keyframes when playing the RIN document.

17. The computer-implemented method of claim 14, further comprising defining a speed at which to go from one keyframe to another keyframe.

18. A rich interactive narrative (RIN) authoring system for allowing an author to author a RIN document, comprising:
a computing device comprising a display device and a user interface input device;
a computer program comprising program modules executed by the computing device, comprising,
a media library containing a plurality of experience streams;
a timeline containing experience streams that have been obtained from the media library and dragged and dropped onto the timeline at a location indicative of the time in the RIN document at which the experience streams should appear;
a keyframe creation and editing module for editing a selected experience stream located on the timeline;
a plurality of keyframes from the selected experience stream that were defined using the keyframe creation and editing module, wherein each of the keyframes represents a user experience state and defines, at any point in time, when an author wants the selected experience stream to appear in the RIN document and what portion of the experience stream at that time will be shown;
a parent narrative generated from the plurality of keyframes; and
a section of a child narrative that is played inside the parent narrative;
wherein the author can author the RIN document without having to program the computing device and without having to write code.

19. The RIN authoring system of claim 18, further comprising a trajectory between the plurality of keyframes defined by the author using the keyframe creation and editing module, the trajectory orchestrating the path through time of the keyframes during playback of the RIN document.

20. The RIN authoring system of claim 19, further comprising multiple tracks contained in the timeline containing multiple layers of visual and audio experiences.
